(19) United States
(12) Patent Application Publication
(10) Pub. No.: US 2011/0191158 A1
(43) Pub. Date: Aug. 4, 2011

(54) PHYSICAL ACTIVITY TRACKING AND REWARDS ALLOCATION SYSTEM

(76) Inventors: Espen D. Kateraas, Aliso Viejo, CA (US); Pedro J. Medelius, Merritt Island, FL (US)

(21) Appl. No.: 13/055,591

(22) PCT Filed: Aug. 19, 2009
(86) PCT No.: PCT/US09/54303

§ 371 Date: Mar. 31, 2011

Related U.S. Application Data
(60) Provisional application No. 61/136,229, filed on Aug. 20, 2008.

(51) Int. Cl. G06Q 30/00; G06F 19/00

(52) U.S. Cl. 705/14.27; 702/19

(57) ABSTRACT

A physical activity tracking system includes one or more data collection portals configured to acquire data from a data collection unit, wherein the data is indicative of the physical activity level of an individual. The system also includes a processor configured to analyze the data and allocate a currency to an account associated with the individual if the data indicates the physical activity level exceeds a predetermined threshold.

### CLAIM OF PRIORITY

This application claims the benefit of priority of U.S. provisional application No. 61/136,229, filed Aug. 20, 2008, the entire disclosure of which is incorporated by reference.

### TECHNICAL FIELD

The present invention relates to a physical activity rewards allocation system and/or a scalable physical activity tracking system for evaluating data relating to the physical activity level of an individual (or group of individuals), for determining one or more rewards based on the data, and/or for allocating the rewards to the individual (or group of individuals).

### BACKGROUND

Physical activity is known to have many health benefits. People who enjoy participating in moderate-intensity physical activities on a regular basis benefit by significantly lowering their risk of developing coronary heart disease, stroke, non-insulin-dependent (type 2) diabetes mellitus, high blood pressure, and colon cancer. Additionally, active people have lower premature death rates than people who are less active.

Nevertheless, obesity is rising to epidemic proportions in many developed nations and many people seldom engage in even moderate-intensity physical activities. As the general physical fitness level of the US population declines, social costs associated with health care continue rise. Such cost increases could be avoided, or even reversed, if people exercised more regularly and became more physically fit.

The presently disclosed system may be configured to automatically track the physical activity level of an individual (or a collective group of individuals) and to allocate a currency or measurement to that individual based on the amount of time the individual's physical activity level exceeds a predetermined threshold or baseline. This currency can then be redeemed, for example, by the same individual, for products, services, or other “rewards,” and, therefore, provides a unique personal incentive for the individual to regularly engage in moderate-intensity physical activities.

This measurement can also be used by third parties including, for example, governments, schools, the military, insurance companies, or any other private or public organization or concern, to determine an individual's active fitness profile and evaluate or measure that profile against a uniform standard of fitness scalable to a broad demographic. An individual's fitness profile may be used to evaluate and adjust health insurance premiums, among other things. An individual's fitness profile may also be used to monitor physical fitness and activities and provide a verifiable and scalable means of tracking physical exercise and activity.

### SUMMARY OF THE INVENTION

One aspect of the disclosure includes a physical activity tracking system that includes one or more data collection portals configured to acquire data from a data collection unit, wherein the data is indicative of the physical activity level of an individual. The system also includes a processor configured to analyze the data and allocate a currency to an account associated with the individual if the data indicates the physical activity level exceeds a predetermined threshold.

Another aspect of the disclosure includes a scalable physical fitness evaluation system. The system may include one or more data collection portals configured to acquire data from a data collection unit, wherein the data is indicative of the physical activity level of one or more individuals. The system also includes a processor configured to maintain a physical fitness profile indicative of physical fitness level for each of the one or more individuals.

### BRIEF DESCRIPTION OF THE DRAWINGS

FIG. 1 is a diagrammatic representation of a physical activity tracking and rewards allocation system according to an exemplary disclosed embodiment.

### DETAILED DESCRIPTION

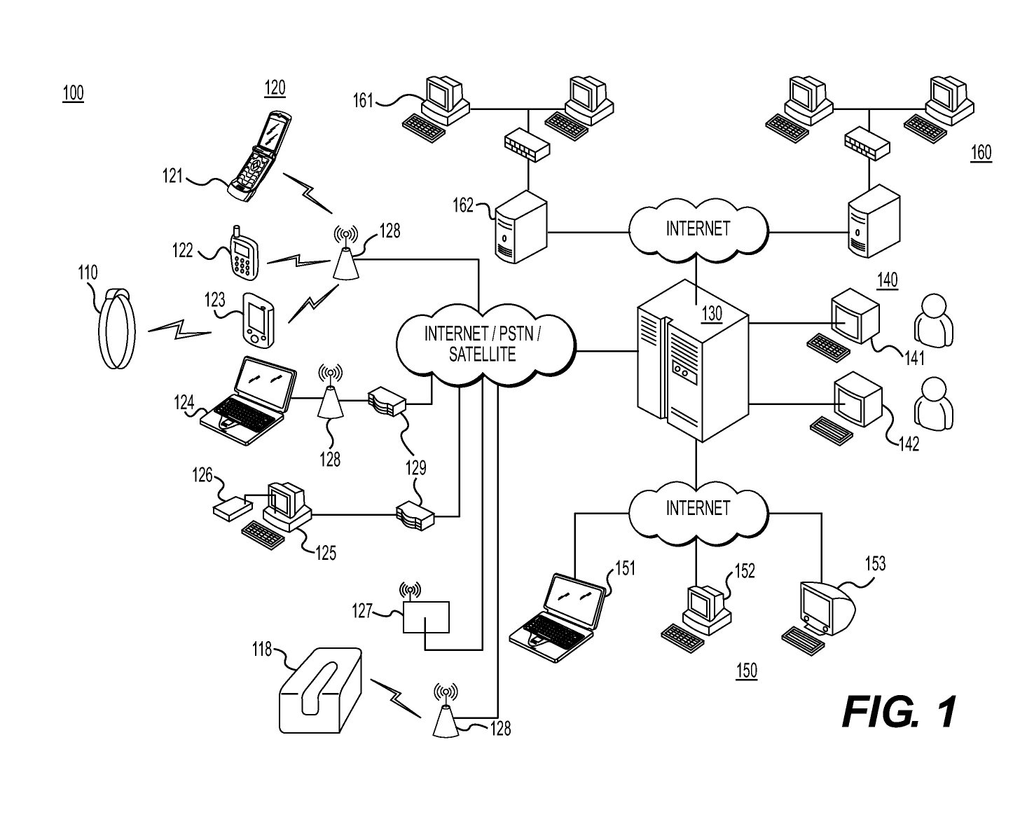

FIG. 1 provides diagrammatic representation of a physical activity tracking and rewards allocation system 100 according to an exemplary disclosed embodiment. System 100 may include any suitable array of components for tracking the physical activity of one or more individuals, determining rewards based on the physical activity level of the one or more individuals, and allocating the rewards to the one or more individuals. In one embodiment, system 100 may include data collection portals 120, a mainframe 130, maintenance terminals 140, user nodes 150, and sponsor access nodes 160. Other embodiments of system 100 may include additional or alternative components where needed to provide any desired functionality for system 100.

System 100 may be configured to communicate and acquire data from one or more data collection units 110. Data collection units 110 may be worn by a user and may include at least one sensor for collecting data indicative of the physical activity level of the user. For example, data collection unit 110 may include a sensor array (including one or more sensors) configured to monitor biological markers that vary with the level of physical exertion of an individual. The monitored biological markers may include, for example, pulse rate, body temperature, physical movement, blood oxygen content, and/or any other suitable marker. Within the sensor array, each sensor may be configured to monitor only a single biological marker. Alternatively, an individual sensor in the array may be configured to monitor multiple biological markers.

Data collection units 110 may be configured to collect and store raw data collected from the sensor array. While it is possible to store raw data collected from the sensor array, a microcontroller on data collection units 110 may alternatively be configured to store processed data. For example, each data collection unit 110 may be configured to calculate pulse rate, pulse rate over time, oxygen content, physical movement, and/or temperature and average each calculated value over periods of up to thirty seconds, sixty seconds, or more to remove noise and enhance accuracy of the readings. The microcontroller can be configured to store these time averaged, filtered temperature/pulse rate/oxygen content/physical movement readings at preselected intervals (e.g., once or twice per minute). Such a scheme can conserve memory resources yet still provide useful information.

The data collected by data collection units 110, whether in raw form, time averaged filtered form, or in another processed format, can be transmitted or collected by system 100 via data collection portals 120. Data collection portals 120 may include any type of device suitably equipped for collecting data from data collection units 110. For example, data collection portals 120 may include a device cradle 118, a reader unit/pod 119, a cellular phone 121, a smart phone 122, a personal data assistant 123, a laptop computer 124, or other type of electronic device that can be configured to communicate with data collection units 110. In one embodiment, data collection portals 120 may be configured to communicate with data collection units 110 via a Bluetooth, wired, optical, or other type of data link. Data collection portals 120 may also include a personal portal 126 configured as a peripheral device to provide a computer 125, for example, with an ability to communicate with a data collection unit 110. Data collection portals 120 may also include a public portal 127. A public portal 127 may include a unit positioned in malls, public parks, fitness centers, sporting fields or any other public or private location frequented by users of data collection units 110.

In certain embodiments, data collection portal 120 may include a cradle unit 118 adapted to hold, or otherwise contact, the data collection unit 110. Such a cradle may facilitate the interrogation of data collection unit 110 and/or the transmission of data between data collection unit 110 and data collection portal 120. For example, in addition to a wireless connection between data collection unit 110 and cradle unit 118, data collection unit 110 and cradle unit 118 may communicate via an electrical pathway formed by physical contact between electrical connection points on data collection unit 110 and corresponding electrical connection points on cradle unit 118. Cradle unit 118 may also be configured to recharge data collection unit 110.

Data transmission to data collection portals 120 may be initiated by either data collection units 110 or data collection portals 120. In one embodiment, data collection portals 120 may be configured to sense the in-range presence of a data collection unit and then initiate collection of data from data collection unit 110. Alternatively, or additionally, data collection unit 110 may be configured to detect the presence of an in-range data collection portal 120 and, in turn, initiate transmission of data to that portal.

In yet another embodiment, data collection portal 120 may be configured to emit an interrogation signal that, when received by a data collection unit 110, may prompt the data collection unit to transmit stored data to the data collection portal 120. For example, rather than data collection unit 110 periodically searching for a suitable data collection portal within range, data collection unit 110 may be configured to simply respond to an interrogation signal continuously or periodically emitted from a data collection portal 120. If data collection unit 110 receives such an interrogation and determines that the emitting data collection portal is within transmission range, then data collection unit 110 can activate a transceiver associated with the data collection unit 110 and commence data transmission.

Transmission between data collection units 110 and data collection portals 120 may be accomplished over any suitable transmission range. In certain embodiments, data collection unit 110 may be configured to transmit data to portals located within about ten feet of a data collection portal 120. In other embodiments, this transmission distance may be extended up to about 50 feet.

Moreover, data transmission may be accomplished via any suitable scheme for transmission of data. In one embodiment, the data stored in data collection unit 110 may be transferred to a data collection portal 120 via a wired connection including a cable and cable interface. Data transmission between data collection unit 110 and data collection portal 120 may also be accomplished via a wireless connection including a radio frequency or optical transmission link. In certain embodiments, for example, data collection unit 110 can be Bluetooth or Zigbee enabled or may transmit data to a data collection portal 120 via an infrared optical link.

When communication is established between data collection unit 110 and a data collection portal 120, download of the data stored on data collection unit 110 may commence, for example, after proper identification of the user and of the portal has been achieved. This may prevent eavesdropping by unauthorized parties. Identification of the user may include transmission of a unique code assigned to each data collection unit and/or user of the data collection unit. A user-selectable password can be used to allow data to be downloaded by the data collection portal.

In other embodiments, passive identification of a user may displace the need for password protected downloads. For example, data collection unit 110 may be configured to determine and store a biological signature of an authorized user of the data collection unit. Such a signature may be determined using the same array of sensors used monitor temperature, blood oxygen level, physical movement, and pulse rate. Alternatively, one or more additional sensors (e.g., a skin pigment sensor, pH sensor, etc.) may be included on data collection unit 110 to aid in user recognition.

Once transmission of data stored in data collection unit 110 commences, a handshaking process may be employed to validate the integrity of the data transmitted and to request retransmission of the data, if necessary. After the data collection unit establishes that the data has been successfully transmitted to the data collection portal, the microcontroller in data collection unit 110 can optionally delete the previously stored data.

Transmission of data to a data collection portal 120 may be controlled based on the availability of stored data. For example, if no new data has been stored in data collection unit 110 since the last successful download, then the microcontroller of data collection unit 110 may determine that there is nothing to transmit. Under these conditions, the data collection unit 110 may forego searching for a suitable data collection portal 120 and will remain powered down despite the presence of a detected in-range data collection portal 120.

Once a data collection portal 120 has received data from a data collection unit 110, that portal can store the data in a memory associated with the portal. Alternatively, or additionally, the receiving portal can simply forward the received data to a mainframe 130, which may be configured to operate as a core unit of system 100 by tracking the physical activity of individuals, allocating rewards, and obtaining scalable measurements of individual physical fitness.

The data received by data collection portals 120 can be transmitted to mainframe 130 by any suitable method and along any suitable communications path. Such communication paths may include wireless repeater units 128, routers 129, and any other communications equipment known in the art. In one embodiment, the data collection portals 120 can communicate with mainframe 130 via a wireless network (e.g., a cellular communications network), the Internet, satellite, public switched telephone network (PSTN), or any combination of these or other communications pathways.

Mainframe 130 may be configured to perform many tasks associated with system 100. For example, mainframe 130 can store and maintain user accounts (e.g., in storage area networks housing a database), process data associated with the physical activity level of individual users, calculate rewards based on the physical activity level of individual users, allocate rewards to user accounts based on the user's physical activity level, and generate or report a user's physical fitness profile. Mainframe 130 can also enable individual users to access their respective accounts, for example, to review physical activity data, review accrued rewards, monitor his or her physical fitness profile, and access any other features provided by system 100. Mainframe 130 may also compile selected data or data summaries and may provide access to this data and/or data summaries to selected entities, including corporate sponsors, health insurance providers, associations, the military, or any other entity that may have an interest in monitoring physical activity data.

Mainframe 130 may include a single server or may include multiple servers networked together. Mainframe 130 may also include power-outage back-up capabilities to secure continuous operation (24/7). Any number of devices may be included as part of or peripheral to mainframe 130. Such devices may include clustered World Wide Web servers, clustered database servers, storage area networks, fiber switches, firewalls, intrusion prevention systems, routers, switches, LTO tape drive, an LTO tape library, an APC InfrastruXure UPS System, and any other device or devices to provide a desired level of functionality. Mainframe 130 may be connected via Fibre Channel to the storage area networks that contain the user database. Connectivity to the Internet may be provided by Gigabit Ethernet connections to a network switch. There also may be redundant paths to the Internet provided by a local ISP using Cisco routers and T1 and/or DS3 connections.

A primary feature offered by physical activity tracking and rewards allocation system 100 is the ability to convert the physical activity level of a user into a “commercial value” or currency that the user can use to purchase various goods or services. In this way, the user may be motivated to exercise or otherwise maintain a particular level of physical activity in order to accrue currency for rewards redemption.

System 100 also offers the ability to use the physical activity of the user as a standard of measurement to determine an individual physical fitness profile, which is scalable for a unique but relative comparison with a broader demographic. Thus, third parties may use a uniform comparative measure of fitness to evaluate and monitor physical activity of one or more individuals and to compare individual physical fitness profiles to a selected broader demographic.

In one embodiment, the currency that can be used to acquire goods and services rewards may take the form of an electronically determined unit calculated based on the time spent in a predetermined physical activity zone or above a system determined individual predetermined threshold or baseline. Such currency may be referred to as activity units. Activity units may be allocated to an individual user account whenever the individual's physical activity pattern exceeds, by a predetermined amount, a stored baseline pattern associated with the individual. The rate at which the individual accrues activity units can be set at any suitable value. For example, in certain embodiments, one activity unit may be accrued for each minute that a user's physical activity level is maintained within a personal activity zone defined by a predetermined threshold above the individual user's baseline pattern. Of course, it is also possible for multiple activity units, or even less than one activity unit, to be awarded for each minute spent in the activity unit zone above the predetermined threshold.

System 100 can be configured to collect and store each user's baseline and zoned activity history and reflect this history in terms of minutes or hours spent within the baseline or zoned activity levels. The number of activity units accrued may be synonymous with the user's personal fitness progression and may be directly reflected by the individual's physical fitness profile. Because activity units may be directly related to time that an individual spends exercising, an individual's fitness level or physically active life style may also be associated with accrued activity units. In general, the more activity units that a user accrues, the greater the fitness level of that user will be. Further, as an individual accrues activity units, the individual's physical fitness profile will likely reflect a higher level of physical fitness and may compare more favorably to a broader demographic. Further, because the user may be motivated to accrue activity units as a currency that can be redeemed for various rewards, the user is essentially motivated to exercise and to achieve a greater fitness level.

Various programs may be instituted to encourage users to accumulate activity units. For example, a user's physical activity status may be categorized to reflect the rate at which the user accrues activity units. If zoned activity reaches up to 1,000 activity units in a 4-week period, for example, the individual may be categorized by system 100 as “moderately active.” Further, if zoned activity reaches more than 1,000 activity units in a four week period, then the user may be categorized as “active.” These categories may be reflected, for example, via the individual's physical fitness profile. Various additional levels or sub-levels may be assigned, as desired, to indicate a user's activity level progression or deterioration over time. In certain embodiments, the rate of activity units accrual may be tied to the user's physical activity status level. For example, a higher status level may translate into a different rate (e.g., a higher rate) of activity units accrual. Providing different rates of accrual for higher physical activity status levels may encourage individuals to move from lower physical activity status levels to higher ones.

Further, various forms of activity unit bonuses may be associated with physical activity status levels. For example, when a user moves to a more active status, a bonus may be awarded. Similarly, bonuses may be awarded for maintaining a certain physical activity status level over a certain period of time. In this way, a user may be motivated not only to exercise in order to accrue activity units currency, but the user may also be motivated to increase his or her physical activity status or to maintain a certain level of physical activity over an extended period of time in order to receive bonuses.

System 100 may be configured to allocate bonuses upon achieving certain milestones. For example, if a user accrues a certain number of activity units (e.g., 1000) within a preselected period of time (e.g., 4 weeks), then a bonus may be awarded to the user. The award of bonuses are not limited to the examples provided. Rather, bonuses may be awarded for any predetermined event relating to the physical activity level of a user.

Conversely, system 100 may also be configured to provide disincentives for becoming less physically active. For example, if a user moves to a lower physical activity status level, he or she may accumulate activity units at a different rate (e.g., more slowly) than at a higher status level. Further, system 100 may be configured to levy a penalty for moving to a lower physical activity status level from a higher status level. System 100 may be configured, however, to recognize potential causes for observed reductions in physical activity and forego penalties, where appropriate. For example, as an individual ages, his or her level of physical activity may decline as a natural part of the aging process. Additionally, an individual may become less physically active following a debilitating injury. Under such circumstances, system 100 may be configured to waive any penalties that would have otherwise been imposed in response to an observed reduction in physical activity.

The algorithm used to calculate activity units based on the recorded physical activity of a user may constitute a multi-part algorithm and may run on either data collection unit 110, on a server associated with mainframe 130, or partially on data collection unit 110 and partially on mainframe 130, or any other suitable computing device associated with system 100. In a first part of the algorithm, a user's physical activity level is monitored to determine whether that activity level qualifies as “zoned” activity for which activity units may be accrued. In a second part of the algorithm, the number of activity units to be awarded may be calculated based at least in part on time that a user spends in zoned physical activities.

In one embodiment, zoned physical activities may be determined based on a predetermined set of criteria applied uniformly to all users of a data collection unit 110. For example, a zoned physical activity may be defined as any activity that causes a measured physical parameter associated with an individual user to exceed a preselected threshold value. One such measured physical parameter may include a user's heart rate, for example. Microcontrollers associated with data collection units 110 may be configured to universally credit users with a zoned physical activity determination whenever the heart rate of those users exceeds a predetermined value (e.g., 110 beats per minute, or some other suitable heart beat threshold). In addition to heart rate, other physical parameters may be used, including, e.g., blood oxygen saturation value, body temperature, physical movement, or any combination of these or other suitable parameters.

In another embodiment, zoned physical activities may be determined according to the unique attributes of a particular user, rather than through application of a universally applied standard. In such an embodiment, the determination of a zoned physical activity may depend on a baseline fitness level for each individual. Such a baseline fitness level may be calculated by monitoring any suitable physical parameter, determining a value for that parameter associated with a resting condition for the user, and using the resting value of the physical parameter as a fitness level baseline unique to an individual. Suitable physical parameters for determining a resting condition of an individual may include, for example, heart rate, blood oxygen saturation level, body temperature, physical movement, or any combination of these or other suitable physical parameter values.

A baseline fitness level may also be determined according to an algorithm that depends on contributions from one or more physical parameter values. For example, an individual's baseline heart rate, IB₁, may be defined as the average of the lowest average heart rate (r) over a certain period of time (t) when the body temperature of the individual is stable. This baseline heart rate value may be represented as:

$${IB}_{1} = \frac{1}{T} {\int }_{0}^{T} r d t$$

An individual's baseline body temperature, IB₂, may be defined as an average of body temperature (f) over certain period of time (t) while the individual experiences his or her lowest average heart rate. The baseline body temperature may be represented as:

$${IB}_{2} = \frac{1}{T} {\int }_{0}^{T} f d t$$

An individual's baseline blood oxygen level, IB₃, may be defined as the average blood oxygen level (b) over a certain period of time (t) while the individual experiences his or her lowest average heart rate. The baseline blood oxygen level may be represented as:

$${IB}_{3} = \frac{1}{T} {\int }_{0}^{T} b d t$$

Once an individual's baseline fitness level is determined by the method outlined above or by any other suitable method (e.g., by monitoring resting heart rate, among others), this baseline fitness level can be used to determine when the physical activity of a user qualifies as zoned physical activity. First, an average sensed vital signs quantity (ASVS) may be calculated based on the outputs of sensors that monitor a user's vital signs or other physical parameters. In the case of an array of sensors that monitor heart rate, blood oxygen level, and body temperature, the ASVS may be represented as:

ASVS=k₁×S₁+k₂×S₂+k₃×S₃

where S₁ represents current blood oxygen level, S₂ represents current heart rate, S₃ represents body temperature, and k₁, k₂, and k₃ are constants.

With the ASVS and the baseline fitness level, a physical activity score (PAS) may be calculated using the following relationship:

PAS=(k₁×S₁)/IB₁+(k₂×S₂)/IB₂+(k₃×S₃)/IB₃

If the PAS exceeds a certain predetermined threshold value, then the physical activity qualifies as zoned physical activity for which activity units may be accrued. Of course, PAS can be determined using any other suitable relationship. For example, an individual's PAS may depend solely on heart rate, any other sensed value, or any combination (weighted or otherwise) of sensed values.

Any portion of the algorithm can run on a data collection unit 110. In one embodiment, a microcontroller onboard at least one data collection unit 110 associated with system 100 may be configured to determine a baseline fitness level of an individual (using IB₁, IB₂, and/or IB₃, or via any other suitable method). The microcontroller may also be configured to calculate an ASVS based on the output of sensors included on data collection unit 110 and determine a PAS by comparing the ASVS to the PAS. The microcontroller can further be configured to monitor and store the total amount of time that the individual's PAS represents zoned physical activity (ZPA_{T}). In such an embodiment, the information transmitted from the data collection unit 110 to any of the data collection portals 120 could include ZPA_{T}. The transmitted data could also include data indicating the baseline fitness level of the user or any data associated with the individual user. Using this ZPA_{T} value, mainframe 130 could determine the amount of activity units that correspond to ZPA_{T} for the particular user. Alternatively, the microcontroller on data collection unit 110 could convert ZPA_{T} to activity units and forward this information to data collection portals 120.

In another embodiment, the microcontroller associated with a data collection unit 110 may be responsible for fewer calculations. In such an embodiment, the microcontroller may be configured to monitor outputs of sensors associated with the data collection unit 110, store these outputs as data, and transmit this data (either conditioned (e.g., by time averaging) or unconditioned) to a data collection portal 120 at regular intervals, when commanded by a user, or when data collection unit 110 is brought within a suitable communication range of a data collection portal 120. In this embodiment, mainframe 130, or another suitable computing device associated with system 100, would be responsible for determining the baseline fitness level of each user of a data collection unit 110; determining ASVS, PAS, and/or ZPA_{T} based on the data forwarded by the data collection unit 110; and determining the number of activity units to be allocated to the individual.

It is also possible that the microcontroller associated with a data collection unit 110 can perform an intermediate portion of the algorithm. In such an embodiment, the microcontroller may be responsible for calculating a baseline fitness level and transmitting that information to data collection portals 120 along with raw or conditioned data relating to the output of sensors included on data collection unit 110. Alternatively, the microcontroller could calculate ASVS, PAS, or ZPA_{T} and forward any of these quantities to data collection portals 110 with any other data relating to the physical activity of the individual.

Thus, system 100 may be configured such that mainframe 130 performs substantially all of the calculations associated with the algorithm and the microcontrollers of data collection units 110 forward the basic underlying data for those calculations. Alternatively, the individual microcontrollers of data collection units 110 can be configured to perform most, if not all, of the calculations associated with the algorithm and forward to mainframe 130 the results of those calculations. Further still, the calculations associated with the algorithm can be shared between mainframe 130 and the microcontrollers of data collection units 110 (or with any other computing device associated with system 100) in any desired proportion. It is even possible to have certain data collection units perform more of the algorithm than other data collection units. Mainframe 130 may be configured to accommodate differences in data provided by the various data collection units associated with system 100.

In the algorithm, the predetermined threshold against which the PAS is compared (i.e., to determine whether physical activity qualifies as zoned physical activity for which activity units may be accrued) may correspond to any desired threshold level. Setting the predetermined threshold lower, rather than higher, however, may minimize the risk of an individual overexerting himself in an attempt to accrue activity units. The purpose of the system or program is to encourage general fitness through moderate exercise. Overexertion can be dangerous. Individuals should be encouraged to exercise well within their physical limits and certainly well below the point of overexertion.

In one embodiment, the threshold (e.g., the IMAT: Individual Minimum Activity Threshold) used to compare against PAS may correspond to a value determined by a medical or health related board or association. Such an IMAT may correspond to moderate-intensity physical activity, such as any activity that requires about as much energy as walking two miles in 30 minutes. The IMAT may also be based, at least in part, on heart rate. For example, the IMAT may correspond to the individual's target heart rate for moderate-intensity physical activity. Such a heart rate value may correspond to about 50% to about 70% of his or her maximum heart rate, which may be based on the age of the individual. For example, an estimate of a person's maximum age-related heart rate can be obtained by subtracting the person's age from 220. Thus, a 50-year-old person has an estimated maximum age-related heart rate of about 170 beats per minute (bpm) (i.e., 220−50). The 50% and 70% levels would be:

50% level: 170×0.50=85 bpm, and

70% level: 170×0.70=119 bpm.

Thus, to encourage moderate-intensity physical activity for a 50-year-old person, the IMAT may be set as a value from about 85 bpm to about 119 bpm.

In another embodiment, the IMAT may be associated with a certain metabolic equivalent level used to measure physical activity intensity. For example, the level of effort expended during a physical activity can be represented in terms of a metabolic equivalent (MET). Such a unit may be used to estimate the amount of oxygen used by the body during physical activity. The energy (or oxygen) required for a body to read a book, for example, may equal 1 MET. In such an embodiment, the IMAT may be set somewhere between about 3 and about 6 METs, which may correspond to a moderate-intensity level.

To encourage general overall fitness of individuals through physical activity, system 100 allocates activity units (i.e., a currency) which can be redeemed for rewards. Such rewards can be monetary. Alternatively or additionally, such rewards may include free or discounted merchandise (e.g., clothes, sporting equipment, airline tickets, food, concert tickets, among many others) or free or discounted services from a sponsoring entity (e.g., hotel visits, spa services, fitness evaluation testing, deductible payments for doctor visits, among many others). Thus, an individual's collected (or earned) activity units represent an individually earned currency or value based on physical activity, as these activity units can be redeemed against commercially available products and services.

As system 100 calculates and awards activity units to an individual user, system 100 updates an account for that individual and adds the newly accrued activity units. Each individual user of a data collection unit 110 may have a unique account in which the activity units accrued and redeemed by the individual can be tracked. Account information may be stored in one or more databases associated with mainframe 130.

System 100 may require maintenance from time to time. For this purpose, system 100 may include one or more internal access nodes 140 to provide system administrators with access to the databases, applications, user data, etc. of system 100. In one embodiment, these internal access nodes 140 include terminals 141, 142 in communication with mainframe 130.

Individuals can access their accounts in any suitable manner. For example, data collection portals 120 may be equipped with a user interface that allows an individual to access his or her account. Additionally, individuals may be able to access account information via user nodes 150. Such user nodes may include, for example, a laptop computer 151, a PC 152, terminal 153, a hand-held device (not shown), or any other device suitable for accessing information. While user nodes 150 are depicted in FIG. 1 as being in communication with mainframe 130 via the Internet (e.g., via a Web-based browser application), any other suitable communications scheme may be employed. Further, in embodiments where data collection units 110 include a display, such data collection units may be configured to allow an individual to view account data on the display. Such access could provide real-time information, such as whether the IMAT has been exceeded, the rate of activity units accrual, the account balance, or any other desired information.

With access to account information, an individual user can determine his or her activity unit balance or review account activity (e.g., activity unit credits or debits corresponding to reward redemption activities, among other account activities). The individual may also print a rewards redemption certificate or coupon, redeem activity units for rewards via an electronic transaction (e.g., by using accrued activity units to make a purchase from an online retailer), change passwords and other administrative tasks, or perform any other account-related activity. System 100 may also be configured to provide an individual's historical activity both in numbers and in graphical form for both accumulated activity units (Activity Histograms) and transacted/redeemed units (e.g., a report of when, where, and how many activity units were redeemed and what product, service, or company, etc. was involved in the transaction). Individual account statements can be produced, printed, and mailed via post and/or e-mail to each individual on a regular basis. Updated statements can also be printed by a user at any time by accessing his or her own individual user account profile and printing locally. These certificates can be used, for example, as evidence of or as a profile reflecting an individual's active lifestyle pattern and/or fitness level progression and as a way of increasing the person's perceived fitness value to a medical entity, insurance provider, employer, the military, or any other institution that values good health and active life styles as essential components to advocating positive social change. Individual users of system 100 may also be e-mailed periodically with special offers. Such offers may include an offer to accrue activity units at a greater rate during a certain limited time period. Such offers may also include access to certain products or services previously unavailable or to products and services at a discounted rate. Such offers may also be associated with observed holidays.

As individual activity unit balances increase, each user may enjoy a higher level of credit expendability and status in the program. E-mail alerts can be sent to update the user about his or her progress and the user's server profile may be updated to reflect user progression.

In certain embodiments, system 100 may also provide access to one or more corporate sponsors, corporations, insurance companies, charitable associations, or other entities. Such access may be achieved via sponsor access nodes 160, which may include one or more computers 161, a server 162, or any other components or devices for providing a communication path (e.g., using the Internet) to mainframe 130.

Such entities may wish to have access to system 100 for various reasons. For example, corporations that utilize data collection units for some portion of their employees may create an accounting principle to record the company's physical activity count (PAC). Such a measure can be recorded, for example, for use in negotiating lower health insurance costs or other employer-related benefits.

Entities (e.g., corporations, military, government, associations, or other groups) may also access system 100 to evaluate the fitness level of a particular individual or a group of individuals. For example, these entities may access and evaluate the physical fitness profile of a particular individual. Alternatively or additionally, these entities may access and analyze the physical fitness profiles of multiple individuals using, for example, a batch processing algorithm to assess the average fitness level of a selected group of individuals. These evaluations may be used, for example, to determine an overall fitness level for one or more particular individuals, employees, troops, members of an organization, etc. Among other uses, this information may be used to verify compliance with physical fitness regulations or goals, to negotiate reduced health insurance premiums, or to obtain subsidies, e.g., from the government or private sponsors, in exchange for maintaining a desired average fitness level among a certain population of individuals.

A user physical fitness profile may include any desired information relating to the physical fitness or physical activities of an individual. In one embodiment, the physical fitness profile may be configured to reflect the number of activity units accrued by the individual, an elapsed time spent participating in zoned physical activities (e.g., total elapsed time, average time per month, week, and/or day, or an amount of time over a selected time period), a physical fitness score or qualifier indicative of the general fitness level of the individual (based, for example, on a predetermined algorithm or set of criteria), a trend in physical fitness level, time spent as a participant in the system or program, and any other desired information relating to the physical fitness of an individual. Physical fitness profiles may also include information relating to vital statistics associated with an individual including, for example, heart rate data, blood oxygen saturation data, body temperature data, and/or physical movement. In addition to individual-specific physical fitness profiles, system 100 may also be configured to determine/maintain a physical fitness profile for a group of individuals (e.g., workers of a common entity, residents of a particular jurisdiction, members of a club or group, military units, etc.).

After acquiring a data collection unit 110 and prior to commencing with the data collection and rewards allocation process, initial registration with system 100 may be performed. This initial registration process may be accomplished by an individual user accessing a website to register a new membership and create a user profile for his or her account. The individual may also provide data to system 100, which may be maintained with the individual's user account. This data may include, among other things, the individual's name, a system password, bracelet ID, telephone number, emergency contact (and contact number), age, sex, geographic location, address, e-mail address, activity preference, other interests, training schedule, upcoming events, reference to personal website, etc. Personal medical data can also be entered in the designated server profile and downloaded to the data collection unit 110 associated with a particular user. This information could potentially be retrieved in an emergency situation by EMT personnel and may include blood type, allergy information, pre-existing conditions such as diabetes level, and emergency contact numbers.

The initial registration process may also include a data collection unit calibration process. This calibration process may begin by powering on the data collection unit and entering a unique PIN for the data collection unit. The PIN enables a system 100, including data collection portals 120 and/or mainframe 130, to recognize each data collection unit 110. PIN verification may be made regularly by server maintenance staff, i.e. once per quarter or semi-annually. It should be noted that this PIN is separate from a PIN that a user may establish to restrict access to the user's account on mainframe 130. Further, rather than entering a PIN manually, data collection unit 110 may be configured to automatically transmit its serial number or other PIN to a data collection portal 120 and, therefore, to mainframe 130 for verification purposes.

Next, data collection unit 110, either together with other components of system 100 or on its own, may proceed with creation of an initial physical activity baseline for the individual. This portion of the calibration process would require the user to wear the data collection unit for a predetermined minimum amount of time (e.g., 24 hours or other suitable period of time) in order to establish a fitness baseline. Once the initial threshold and/or baseline is established, the data collection unit is ready to collect physical activity data. An indicator light, display, or other type of indicator can be used to alert the user when a suitable fitness baseline has been achieved and the data collection unit is ready for normal operation.

System 100 can be configured to automatically recalibrate data collection unit 110 on a periodic basis. For example, a new baseline fitness level may be determined by each data collection unit 110 after a certain amount of time has passed (e.g., weekly, monthly, or at any other desired interval) or whenever a certain amount of zoned physical activity has been measured (e.g., after 20 hours or any other desired amount of zoned physical activity has been observed). Alternatively, this recalibration process could be configured to occur on a continuous basis. That is, as system 100 acquires data, the baseline fitness level of a user could be continually updated to reflect the most current fitness level for that individual.

Certain regulations may be instituted regarding the availability of activity units for redemption of rewards. In general, however, activity units are simply accrued in each user's individual account and can be redeemed at any point in time against member/sponsor companies' products and services. Each member company may determine what it would like to offer in exchange for a certain number of activity units. Each member company or government institution may also determine the period of time that its offer (discount or credit) is commercially valid (e.g., for 30 days or up to a year or more). In other words, some companies may have a more or less aggressive offering than others, both in terms of value and time.

The redemption process can be performed either electronically or in person. For example, a user may access an online website of a sponsor company or entity where certain products may be procured at least in part through redemption of activity units. Additionally, vouchers or coupons may be printed and presented to a corporate supplier or other entity for redemption in a traditional “bricks and mortar” retail setting.

Redemption may be made through a reward program or other website for any products or services offered through that site. Additionally, redemption may be made in person or through the website of any sponsoring corporation or entity that offers products or services through its own retail outlets (e.g., electronic or traditional stores). Further still, it is envisioned that redemption may occur at the retail outlets of non-sponsoring corporations that sell the products or services of sponsoring corporations or entities. For example, activity units could be used to purchase a bicycle made by a program-sponsoring bicycle manufacturer even when the bicycle is sold by a retail store with, perhaps, no affiliation with the program.

System 100 may be configured to provide a host of other features. For example, system 100 may be configured to verify individual fitness center attendance to a program enabled fitness center. System 100 may also be configured to incorporate and utilize GPS data. Such information may be used to enable individual location tracking or collection of geographical location information for mapping, routing, and planning purposes. In one embodiment, data collection unit 110 may incorporate a GPS capability to acquire and store specific cycling or running routes that can later be accessed and printed via a user profile and/or shared with other users registered with the program.

Given the data collection unit's multi-functional sensing and registration capabilities, other data may be collected, stored and transferred to/from mainframe 130. Such data may include, for example, athletic event timing information, such as start times, split times, and finishing times (or any other measure of individual timing performance) for running, walking, cycling, skiing, and triathlon events, among others.

The data collection unit may also function as an individual verifier and method of payment for individual entry to affiliated (designated) partner programs' facilities or service offerings. For example, a data collection unit may be configured to operate at least partially as an automatic debit system in which a user can automatically access an accumulated activity units simply by entering or establishing a communication link with a program sponsoring entity. In this way, a data collection unit could be used much like a debit card to access the user's accrued activity units balance rather than cash. A data collection unit may also be configured to allow an event participant to use accrued activity units as payment for registering for such events.

System 100 may also be configured to include user groups and other community features. Such features may include services, such as online advertising, news and promotional sharing, personal/social networking, event and sports promotion, sporting results, e-mails, blogs etc. System 100 may also include chat rooms or other public communications forums.

In general, system 100 may provide a convergent marketplace between individual users, the broader community, and sponsoring companies/organizations as a way of encouraging more active and healthy life styles through physical fitness. Consequently, the program community may include any group affiliated with an active lifestyle. Such groups may include those affiliated with individual sports, such as walking, running, cycling, skiing, swimming, triathlons, golf and tennis, or team sports, such as football/soccer, baseball, basketball, volley ball, ice hockey, etc. Route information and other special interest information may be shared among users of system 100. Such information may be even more readily available where system 100 includes a GPS capability.

System 100 could also be used as a service center to help communicate local, regional, national, and/or international information to the various users. Such information may include, for example, information relating to planned walks, runs, cycling events or other athletic/cultural or community-based activities that promote physical fitness and/or healthy/charitable lifestyles. System 100 may also offer information about local/regional/national member gyms, fitness and health clubs, or sports rehabilitation medicine or physical therapy facilities as a way of encouraging more people towards sanctioned programs at these facilities.

System 100 may be configured to provide bonuses for individuals competing or participating in certain sanctioned events. System 100 can also be configured to maintain an events database and store information relating to these events for later access. This way, individuals may be able to look up their events history and keep track of past performances across various sporting activities while earning authorized bonuses for participating in such events.

System 100 may be equipped with several fraud detection and/or prevention safeguards. For example, each data collection unit 110 may be provided with a unique serial number that can be regularly verified by mainframe 130. System 100 may require a user ID and password for access to user account information. System 100 may be configured to recognize unusual or “out-of-range” data that may have been fraudulently generated. System 100 may also be configured to determine a bio signature for an individual user based on outside temperature and one or more of the user's body temperature, blood oxygen level, physical movements, and heart rate information, for example. By recording a history for these values, or by monitoring other criteria, system 100 may be able to detect whether certain measured values or average values are outside of expected ranges for a particular individual. For example, if a 65 year old individual generates heart rate readings consistently above 190 beats per minute over a certain period of time, and historical data does not show such a high heart rate from past use of the device, system 100 may flag this account as potentially including fraudulently generated data. Under such circumstances, system 100 may generate an automated message requesting that the user explain the circumstances surrounding the physical activity during which the suspect data was acquired. System 100 may also be configured to forego an award of activity units upon detection of suspected fraudulent activity.

It will be apparent to those skilled in the art that various modifications and variations can be made in the disclosed systems and methods without departing from the scope of the disclosure. Other embodiments of the disclosed systems and methods will be apparent to those skilled in the art from consideration of the specification and practice of the disclosure disclosed herein.

What is claimed is:

1. A physical activity tracking system, comprising:
one or more data collection portals configured to acquire data from a data collection unit, wherein the data is indicative of the physical activity level of an individual; and
a processor configured to analyze the data and allocate a currency to an account associated with the individual if the data indicates the physical activity level exceeds a predetermined threshold.

2. The system of claim 1, wherein the data collection portals acquire the data via wireless transmission.

3. The system of claim 1, wherein the data includes at least one of heart rate data, blood oxygen saturation level data, physical movement, or body temperature data associated with the individual.

4. The system of claim 1, wherein the data includes an amount of time the individual has participated in a physical activity at a level exceeding the predetermined threshold.

5. The system of claim 1, wherein the predetermined threshold is determined for an individual based on one or more of the individual's baseline heart rate, baseline body temperature, or baseline blood oxygen level.

6. The system of claim 1, further including a database, the processor being further configured to provide access to user accounts maintained on the database.

7. The system of claim 6, wherein access to the user accounts is provided over the Internet via a Web-based browser.

8. The system of claim 1, further including an identification component configured to identify an authorized user of the system.

9. The system of claim 1, wherein the processor is further configured to assign a physical fitness qualifier to the individual based on the data.

10. The system of claim 9, wherein the physical fitness qualifier includes a physical activity status level.

11. The system of claim 9, wherein the physical fitness qualifier is maintained as part of a physical fitness profile unique to the individual.

12. The system of claim 1, wherein the currency is redeemable by the user in exchange for products or services or discounts on products or services.

13. A physical fitness evaluation system, comprising:
one or more data collection portals configured to acquire data from a data collection unit, wherein the data is indicative of the physical activity level of one or more individuals; and
a processor configured to maintain a physical fitness profile indicative of physical fitness levels for each of the one or more individuals.

14. The system of claim 13, wherein the processor is further configured to provide at least one entity with access to the physical fitness profiles of the one or more individuals.

15. The system of claim 13, wherein the processor is configured to evaluate and report on the average physical fitness level of the one or more individuals.
